(19) United States
(12) Patent Application Publication
(10) Pub. No.: US 2020/0336251 A1
(43) Pub. Date: Oct. 22, 2020

(54) BLOCK PARTITIONING OF REPETITIONS

(71) Applicant: Nokia Technologies Oy, Espoo (FI)

(72) Inventors: Xiaojun CHEN, Hangzhou (CN); Zhenting LI, Hangzhou (CN)

(21) Appl. No.: 16/765,395

(22) PCT Filed: Dec. 1, 2017
(86) PCT No.: PCT/CN2017/114191

§ 371 Date: May 19, 2020

(51) Int. Cl. H04L 1/18; H04L 5/00; H04L 5/10

(52) U.S. Cl. CPC H04L 1/189; H04L 1/188; H04L 5/0051; H04L 5/10; H04L 5/0082

(57) ABSTRACT

Embodiments of the present disclosure relate to a method and device for block partitioning of repetitions. In example embodiments, it is determined whether a time length from a starting time point of the plurality of repetitions to a transmission stopping time point is below a first threshold length. If it is determined that the time length is below the first threshold length, it is determined whether the time length exceeds a second threshold length, the second threshold length being less the first threshold length. If it is determined that the time length exceeds the second threshold length, the plurality of repetitions are partitioning based on a reference block length into a block and a truncated block, the block having the reference block length and the truncated block having a truncated block length shorter than the reference block length. In this way, higher and much more stable demodulation performance and receiving performance may be achieved.

### TECHNICAL FIELD

Embodiments of the present disclosure generally relate to the field of telecommunications, and in particular, to a method and device for block partitioning of repetitions.

### BACKGROUND

Narrow Band Internet of Things (NB-IOT) is increasingly notable in the field of future wireless and Internet of Things (IOT) technologies. In the third generation partner project (3GPP) standardization, the NB-IOT specification partially inherits from the Long Term Evolution (LTE) specification. In addition, the NB-IOT specification has a lot of specific characteristics, such as a narrow band, a requirement of enhancing transmission coverage, a half-duplex transmission mode, and the like. Accordingly, many LTE receiver algorithms (or techniques) cannot be applicable to a NB-IOT receiver. There is a need of designing dedicated NB-IOT receiver algorithms aimed at the corresponding characteristics in order to improve transmission performance. With the increasing deployment of NB-IOT networks in more and more regions, the above need is more and more vital and significant.

In order to enhance the transmission coverage, it is proposed that multiple repetitions are used for one transmission and one of the repetitions may occupy multiple time slots. At a receiver, the repetitions may be combined before decoding so as to increase decoding performance, such as a decoding gain. Typically, channel conditions, such as fading and noises, are estimated before demodulation at the receiver to improve demodulation performance. Considering slow fading channel characteristics due to low mobility of the NB-IOT receiver, such estimation is proposed to be based on a block of repetitions. For example, multiple repetitions are transmitted on an uplink traffic channel, such as Narrowband Physical Uplink Shared Channel (NPUSCH). As specified in the 3GPP standards, the repetitions on the NPUSCH include Demodulation Reference Signals (DM-RSs) that are typically distributed evenly into all transmitted slots. For example, for NPUSCH format 1 (Data), there is one Orthogonal Frequency Division Multiplexing (OFDM) symbol for the DMRS among total 7 OFDM symbols for each slot. For NPUSCH format 2 (ACK/NACK), there are 3 OFDM symbols for the DMRS. At the receiver, upon the reception of one of the blocks, the channel conditions are estimated by averaging the DMRS symbols within the block.

However, due to the half-duplex transmission mode as well as very limited resources of a NB-IOT network, a lot of repetitions are postponed once or multiple times during one transmission in both an uplink direction and a downlink direction. In one conventional approach to address these postponements, when the repetitions are postponed, a block will be postponed across the postponed transmission time which may cause the block longer than the coherent time of the propagation channel. In another conventional approach, a block is truncated when a postponement occurs. This may result in insufficient statistical samples of the reference signals from one block. As a result, the estimation of the channel conditions is relatively inaccurate, and therefore the receiving performance is seriously deteriorated.

### SUMMARY

In general, example embodiments of the present disclosure provide a method and device for block partitioning of repetitions.

In a first aspect, a method is provided. According to the method, it is determined whether a time length from a starting time point of the plurality of repetitions to a transmission stopping time point is below a first threshold length. If it is determined that the time length is below the first threshold length, it is determined whether the time length exceeds a second threshold length, the second threshold length being less the first threshold length. If it is determined that the time length exceeds the second threshold length, the plurality of repetitions are partitioning based on a reference block length into a block and a truncated block, the block having the reference block length and the truncated block having a truncated block length shorter than the reference block length.

In a second aspect, there is provided a communication device. The network device comprises a controller and a memory including instructions. The instructions, when executable by the controller, cause the communication device to perform the method according to the first aspect.

In a third aspect, there is provided a computer readable storage medium tangibly storing a computer program thereon. The computer program includes instructions which, when executed by at least one processor, cause the at least one processor to carry out the method according to the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows example ideal block partitioning of NPUSCH repetitions without consideration of postponements;

FIG. 2 shows example postponement of the NPUSCH repetitions partitioned in the approach as shown in FIG. 1;

FIGS. 3A and 3B show two conventional approaches of block partitioning for the transmission gaps;

FIG. 4 shows an example communication network in which embodiments of the present disclosure can be implemented;

FIG. 5 shows an example influence of inaccurate channel and noise estimation;

FIG. 6 shows an example block partitioning of repetitions according to some embodiments of the present disclosure;

FIG. 7 shows a flowchart of an example method in accordance with some embodiments of the present disclosure; and

FIG. 8 shows a block diagram of a device suitable for implementing embodiments of the present disclosure.

Throughout the drawings, the same or similar reference numerals represent the same or similar element.

### DETAILED DESCRIPTION

Embodiments of the present disclosure will be described in more details with reference to the drawings. Although the drawings show some embodiments of the present disclosure, it is to be understood that the present disclosure may be implemented in various manners and should not be construed as being limited to the embodiments explained herein. On the contrary, the embodiments are provided for a more thorough and complete understanding of the present disclosure. It is to be understood that the drawings and embodiments of the present disclosure are only for the purpose of illustration, without suggesting any limitations on the protection scope of the present disclosure.

As used herein, the term “network device” refers to a base station or other entities or nodes having a particular function in a communication network. The term “base station” (BS) may represent a node B (NodeB or NB), an evolution node B (eNode B or eNB), a remote radio unit (RRU), a radio frequency head (RH), a remote radio head (RRH), a relay, or a low power node, such as a picocell or a femtocell, or the like. In the context of the present disclosure, the terms “network device” and “base station” are used interchangeably for the sake of discussion.

As used herein, the term “terminal device” or “user equipment” (UE) refers to any terminal devices capable of wireless communications with each other or with the base station. As an example, the terminal device may comprise a mobile terminal (MT), a subscriber station (SS), a portable subscriber station (PSS), a mobile station (MS) or an access terminal (AT), and the above devices mounted on a vehicle. In the context of the present disclosure, the terms “terminal device” and “user equipment” are used interchangeably for the sake of discussion.

As used herein, the term “uplink” or (UL) refers to a direction from a terminal device to a network device. UL data or control information refers to data or control information transmitted from the terminal device to the network device. The term “downlink” refers to a direction from a network device to a terminal device. DL data or control information refers to data or control information transmitted from the network device to the terminal device.

As used herein, the term “includes” and its variants are to be read as open terms that mean “includes, but is not limited to”. The term “based on” is to be read as “based at least in part on”. The term “one embodiment” is to be read as “at least one embodiment”. The term “a further embodiment” is to be read as “at least one further embodiment”. Definitions related to other terms will be presented in the following description.

As described above, in the NB-IOT network, the repetitions can be transmitted in both the uplink and downlink directions to enhance the transmission coverage. Considering the need of estimating the channel conditions at the receiver as well as the slow fading channel characteristics, at the receiver, the received signal is partitioned into blocks and the channel conditions are estimated by averaging the reference signal samples (for example, the DM-RS samples) within the respective blocks.

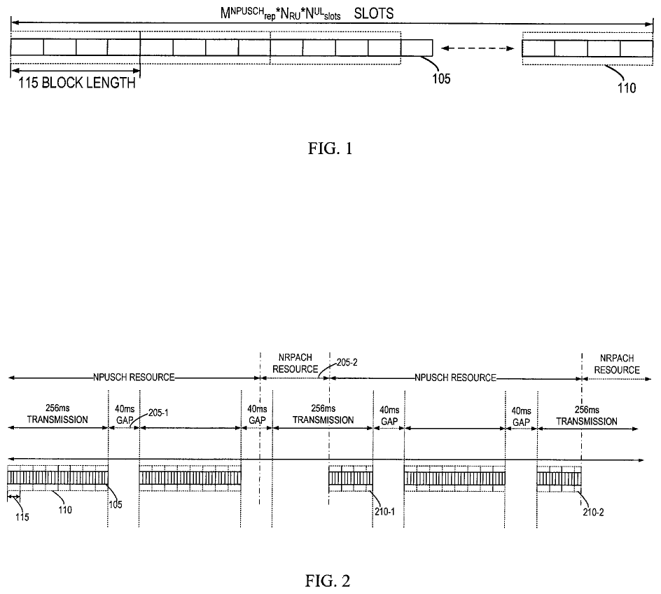

FIG. 1 shows example ideal block partitioning of repetitions in the NPUSCH (also referred to as NPUSCH repetitions) without consideration of postponements. The NPUSCHAs shown, the NPUSCH repetitions 105 occupy M^{NPUSCH}ᵣₑₚ*N_{RU}*N^{UL}ₛₗₒₜₛ time slots, where M^{NPUSCH}ᵣₑₚ represents the total number of the NPUSCH repetitions 105, N_{RU} represents the number of resource units (RUs) used by each of the NPUSCH repetitions 105, and N^{UL}ₛₗₒₜₛ represents the number of slots included in one of the RUs. In this example, four NPUSCH repetitions 105 are grouped into one block 110 which has a block length 115 of 4*N_{RU}*N^{UL}ₛₗₒₜₛ.

In this example, the NPUSCH repetitions include DM-RSs. The channel conditions are estimated based on all DM-RS symbols within one block 110 in the following equations (1) and (2):

$$\begin{matrix}\hat{H} = {averaging}_{one block} ( {Y}_{k} {S}_{DMRS , k}^{*} ) & ( 1 ) \\ {\hat{σ}}^{2} = {averaging}_{one block} ( {\vert \hat{H} - {Y}_{k} {S}_{DMRS , k}^{*} \vert}^{2} ) & ( 2 )\end{matrix}$$

where Yₖ represents the statistical DM-RS samples in the received signals in the frequency domain, k represents the number of the statistical DM-RS samples, and S*_{DMRS,k} represents the known DM-RS symbols. This estimation approach is feasible and has low complex.

Typically, the estimation accuracy depends from the number of statistical DM-RS samples within one block as well as channel invariance during one block. Thus, the block length should be designed specially. On one side, the block length should not be longer than the coherent time of the propagation channel. Otherwise, the channel cannot be considered almost unchanged within one block. On the other side, the block length should not be too short to obtain sufficient samples of the reference signals for relatively accurate estimation of the channel and noise power. Once the block length is determined, the repetitions can be partitioned into respective blocks from beginning to end with the block length.

However, there are many transmission gaps during the uplink and downlink transmission in the NB-IOT network due to the half-duplex transmission mode and the very limited resources. The uplink and downlink transmission has to be postponed (or suspended) during these gaps. Using the conventional block partitioning approaches, such postponement may influence the block length and further the estimation performance. For example, a block will be postponed along with the transmission and finally postponed across the postponed transmission time. This block may last for the channel non-coherent time. Alternatively, a block will be truncated when a postponement occurs which may result in insufficient statistical samples of the reference signals from one block.

FIG. 2 shows example postponement of the NPUSCH repetitions partitioned in the approach as shown in FIG. 1. As shown in FIG. 2, during the uplink transmission, there are many 40 ms gaps 205-1 between 256 ms continuous transmissions. These gaps are used by the terminal device for frequency offset estimation, for example. There are some other gaps 205-2 due to uplink resource reservation for a Narrowband Physical Random Access Channel (NPRACH). The NPRACH resources are typically periodic opportunities configured, for example, in system information. The terminal device can use the NPRACH resources to access the network. The gaps 205-2 are introduced to avoid collisions between the NPUSCH and NPRACH transmissions. For the purpose of discussion, the gaps 205-1 and 205-2 are collectively referred to as gaps 205.

These gaps 205 cause the NPUSCH transmission to become a discontinuous process which may suspend and resume for a lot of times. Such suspension and resumption causes some blocks 110 truncated as truncated blocks 210-1 and 210-2 (collectively referred to as a “truncated block 210”). From the truncated blocks 210-1 and 210-2, insufficient statistical DM-RS samples may be obtained for the channel and noise estimation at the receiver. As a result, the whole receiving performance is seriously deteriorated.

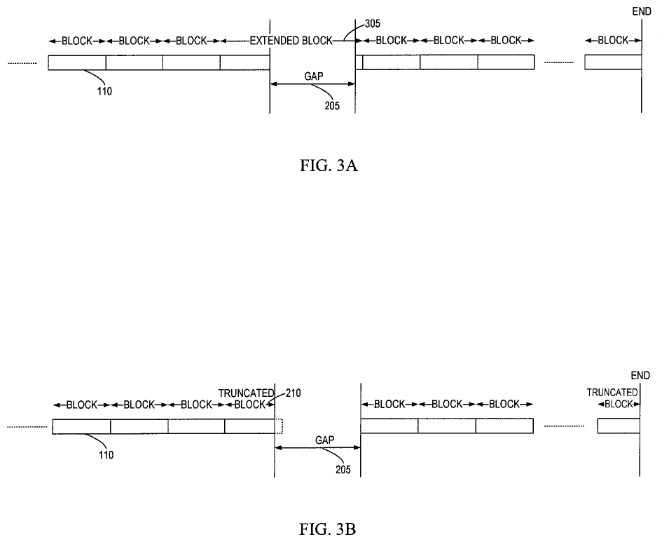

FIGS. 3A and 3B show two conventional approaches of block partitioning for the transmission gaps. In the approach as shown in FIG. 3A, a block 305 is postponed during the gap 205. In this example, the valid block length is constant, and therefore the implementation of the channel and noise estimation is invariable due to constant statistical samples. This approach is feasible and simple.

However, since the gap 205 (for example, including 40 ms UL gap and/or a NPRACH resource duration) may be greater or even far greater than the coherent time of the wireless propagation channel, the averaging operation within one block may actually span a variable channel rather than a constant channel. Therefore, the estimation may not be accurate enough, which will seriously deteriorate the receiving performance.

In the approach as shown in FIG. 3B, the block prior to the gap 205 is truncated as the truncated block 210. That is, the block partition is based on an early stop prior to the gap 205. The resulting block will not be longer than the coherent time of the propagation channel. However, if the truncated block length is too short to obtain sufficient samples of the reference signals, the estimation of the channel and noise power will also be relatively inaccurate.

Embodiments of the present disclosure provide an adaptive scheme of block partition for the channel and noise estimation. In this adaptive scheme, the lengths of the blocks are dynamically adjusted based on occurrences of transmission stopping time points. Each time when a plurality of repetitions are to be partitioned into one or more blocks, a time length from a starting time point of the repetitions to a transmission stopping time point is compared with a threshold length. If the time length is below the threshold length, the time length is compared with a different shorter threshold length. If the time length exceeds the shorter threshold length, these repetitions are partitioned based on a reference block length into a block and a truncated block. In some embodiments, if the time length is below the shorter threshold length, the repetitions may be partitioned into an extended block.

Compared with the conventional approaches, the block partitioning according to embodiments of the present disclosure adopts an adaptive block length before each occasion of the transmission stopping time points. This new partitioning approach considers both the coherent time of the wireless propagation channel and the number of statistical samples for averaging. Accordingly, it can be ensured that the last block before each transmission stopping time point has enough statistical samples. Meanwhile, the block partition may be restarted at the end of each transmission stopping time point to avoid the issue that the block length is longer than the coherent time of the propagation channel. This approach can achieve higher and much more stable demodulation performance and receiving performance.

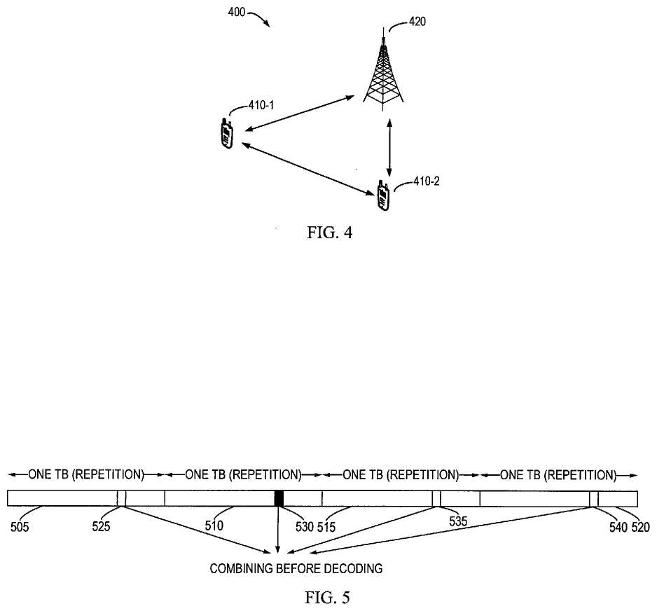

FIG. 4 shows an example communication network 400 in which embodiments of the present disclosure can be implemented. As an example, the network 400 may be a NB-IOT network. Other implementations of the network 400 are also possible. The network 400 includes two terminal devices 410-1 and 410-2 (collectively referred to as “terminal devices” 410) and a network device 420. It is to be understood that the numbers of network devices and terminal devices as shown in FIG. 4 is only for the purpose of illustration, without suggesting any limitations. The network 400 may include any suitable number of network devices or terminal devices.

The terminal device 410-1 may communicate data or control signaling with the network device 420 or with the terminal device 410-2 via the network device 410 by using any suitable communication technology and following any suitable communication standard. Examples of the communication technology include, but are not limited to, Long Term Evolution (LTE), LTE Advanced (LTE-A), Orthogonal Frequency Division Multiplexing (OFDM), Wideband Code Division Multiple Access (WCDMA), Code Division Multiple Access (CDMA), Global System for Mobile (GSM), Wireless Local Area Network (WLAN), Worldwide Interoperability for Microwave Access (WiMAX) Bluetooth, ad hoc, Zigbee, and/or any other technologies either currently known or to be developed in the future.

The data or control signaling can be transmitted in repetitions so as to enhance the transmission coverage. By way of example, in the uplink direction, the terminal device 410 may transmit a transport block (TB) to the network device 420 in the NPUSCH repeatedly for many times, and each TB forms a repetition. The network device 420 combines soft bits of all repetitions with corresponding positions, or uses a maximum-ratio combining (MRC) for all repetitions with the corresponding positions, as below:

$${\sum }_{i} \frac{{\hat{H}}_{i}^{*}}{{\hat{σ}}_{i}^{2}} {Y}_{i}$$

where i represents the number of repetitions, which can be from 1 to 128.

For either soft bits combining or MRC, the weight of each element is

$$\frac{{\hat{H}}_{i}^{*}}{{\hat{σ}}_{i}^{2}} ,$$

when the statistical samples are too few, both [symbol] and [symbol] are very inaccurate, and [symbol] may be much smaller than the real noise power [symbol] . Since [symbol] is the denominator of the weight, the finally combined result will be deteriorated seriously by the bad

$$\frac{{\hat{H}}_{i}^{*}}{{\hat{σ}}_{i}^{2}} {Y}_{i} ( i = k , k = 1 , 2 , … , 128 ) ,$$

even though other

$$\frac{{\hat{H}}_{i}^{*}}{{\hat{σ}}_{i}^{2}} {Y}_{i} ( i = 1 , 2 , k - 1 , k + 1 , … , 128 )$$

are quite good.

FIG. 5 shows an example influence of the inaccurate channel and noise estimation (for example, [symbol] and [symbol] ) on the decoding performance. As shown in FIG. 5, the network device 420 receives four repetitions 505, 510, 515, and 520 from the terminal device 410 in the NPUSCH and combines data segments 525, 530, 535, and 540 with the corresponding positions in these repetitions 505, 510, 515, and 520 before decoding. In this example, the data segment 530 is bad due to the inaccurate channel and noise estimation. Accordingly, the bad data segment 530 may decrease the combining efficiency of data segments 525, 530, 535, and 540 and further deteriorate the decoding performance.

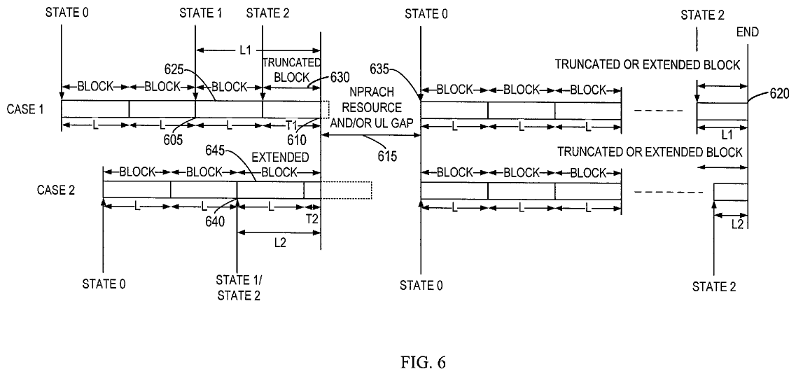

With the conventional approaches of block partitioning, the block length is either too short or too long due to occasions of the gaps. As a result, the number of the statistical samples of the reference signals (for example, DM-RSs) is too less, or the block length exceeds the coherent time of the propagation channel, which may result in the inaccurate estimation. According to embodiments of the present disclosure, an adaptive block length can be determined before each occasion of the transmission stopping time points. Principles and implementations of the present disclosure will be described in detail below with reference to FIG. 6.

FIG. 6 shows an example block partitioning of repetitions according to some embodiments of the present disclosure. Two cases (Case 1 and Case 2) are shown. In Case 1, at state 0, the transmission of repetitions is started in the uplink or downlink direction after a gap (not shown). The repetitions are continuously to be partitioned into different blocks, for example, with a predetermined block length L. It is to be understood that the predetermined block length L is used only for the purpose of illustration without suggesting any limitation. In some embodiments, the block length may be adapted based on the channel conditions to further improve the receiving performance.

A time length L1 from a starting time point 605 of a plurality of repetitions to a transmission stopping time point is compared with a threshold length (referred to as a “first threshold length”). In this example, the first threshold length is equal to two times of the predetermined block length, such as 2*L. Other values of the first threshold length are possible according to actual requirements for example due to the channel variation.

The transmission stopping time point may be any suitable time point when the transmission of the repetitions has to be stopped and which is known by the terminal device 410 and the network device 420 in advance. In this example, the transmission stopping time point includes a starting time point 610 of a gap 615 subsequent to the repetitions (or the most recent gap 615), such as a gap caused by the NPRACH resource and/or an uplink transmission gap for the frequency offset estimation, or a transmission end 620.

If the time length L1 is below the first threshold length, state 0 is transferred to state 1. At state 1, it is determined that whether the repetitions are partitioned into a block 625 with a reference block length (for example, the predetermined block length L) and a truncated block 630, or into an extended block. In various embodiments of the present disclosure, the truncated block has a truncated length T1 shorter than the reference block, and the extended block has an extended length longer than the reference block.

The determination is implemented based on a further threshold length (referred to as a “second threshold length”) which is less than the first threshold length. If the time length L1 exceeds the second threshold length, it is determined that the repetitions are partitioned into the block 625 (for example, with the length L) and the truncated block 630 with the truncated length (for example, the truncated length T1).

The State 1 is then transferred to state 2. In this example, each of the repetitions includes a DM-RS. In this case, at the receiving side, for the last block 630 before the most recent gap 615 (or the transmission end 620), the channel and noise estimation is performed based on the DM-RSs within the truncated block 630. State 2 is transferred to state 0 again at the end 635 of the gap 615, as shown.

In Case 2, when a time length L2 from a starting time point 640 of a plurality of repetitions to a transmission stopping time point (for example, the starting time point 610 of the gap 615 or the transmission end 620) is below the first threshold length, state 0 is transferred to state 1 where it is determined whether the time length L2 is below the second threshold length. After determining that the time length L2 is below the second threshold length, the repetitions are partitioned into an extended block 645 with an extended block length which is equal to L+T2, for example. Then, state 1 is transferred to state 2.

An example of how to partition the repetitions based on the second threshold length will be described below. In this example, the second threshold length is equal to L+alpha*L, where alpha has a range of a floating point value 0˜1. In Case 1 where the time length L1 exceeds the second threshold length, the repetitions are partitioned into the block 625 with the length L and the truncated block 630 with the truncated length T1 (T1>=alpha*L). In Case 2 where the time length L2 is below the second threshold length, the repetitions are partitioned into the extended block 645 with the extended length L+T2.

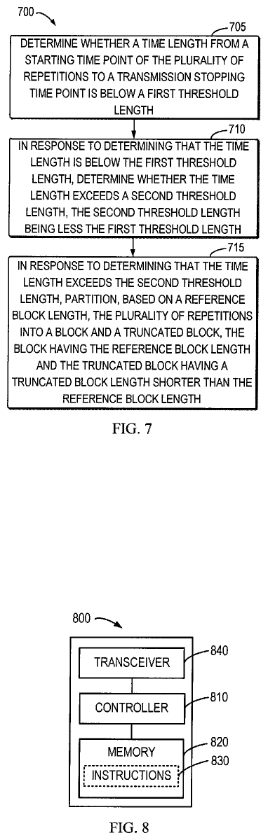

FIG. 7 shows a flowchart of an example method 700 in accordance with some embodiments of the present disclosure. The method 700 can be implemented at a receiver, such as the terminal device 410 or the network device 420 as shown in FIG. 4. For the purpose of discussion, the method 700 will be described with reference to FIG. 4.

At block 705, it is determined whether a time length from a starting time point of the plurality of repetitions to a transmission stopping time point is below a first threshold length. At block 710, if it is determined that the time length is below the first threshold length, it is determined whether the time length exceeds a second threshold length, the second threshold length being less the first threshold length. At block 715, if it is determined that the time length exceeds the second threshold length, the plurality of repetitions are partitioned based on a reference block length into a block and a truncated block. The block has the reference block length, and the truncated block has a truncated block length shorter than the reference block length.

In some embodiments, if it is determined at block 710 that the time length is below the second threshold length, the plurality of repetitions may be partitioned into an extended block. The extended block has an extended block length longer than the reference block length.

In some embodiments, the first threshold length may be equal to two times of the reference block length.

In some embodiments, the second threshold length may be defined as a function of the reference block length.

In some embodiments, the transmission stopping time point includes at least one of a starting time point of a gap subsequent to the plurality of repetitions or a transmission end.

In some embodiments, if it is determined that the time length exceeds the first threshold length, a part of the plurality of repetitions may be partitioned into a further block having the reference block length.

In some embodiments, each of the plurality of repetitions may include a demodulation reference signal.

It is to be understood that all operations and features as described above with reference to FIGS. 4-6 are likewise applicable to the method 700 and have similar effects. For the purpose of simplification, the details will be omitted.

FIG. 8 shows a block diagram of a device 800 suitable for implementing embodiments of the present disclosure. The device 800 can be used for implementing a communication device, such as the terminal network device 410 and/or the network device 420 as shown in FIG. 4.

As illustrated, the device 800 comprises a controller 810, which controls operations and functions of the device 800. In some embodiments, the controller 810 may perform various operations, for example, by means of instructions 830 stored in a memory 820 coupled to the controller 810. The memory 820 may be of any types suitable for local technology environments and may be implemented using any suitable data storage techniques, which includes, but is not limited to, a semiconductor based storage device, a magnetic storage device and system, and an optical storage device and system. Although FIG. 8 only illustrates one memory unit, the device 800 may comprise several physically distinct memory units.

The controller 810 may be of any types suitable for the local technology environments and may include, but not limited to, one or more of a general-purpose computer, a special purpose computer, a microcontroller, a digital signal processor (DSP), and a multi-core controller architecture based on controllers. The device may also comprise a plurality of controllers 810. The controllers 810 are coupled to the transceiver 840. The transceiver 840 may receive and transmit information via one or more antennas, cables or fibers, and/or other components.

The controller 810 and the memory 820 may cooperate to perform the method 700 as described above with reference to FIG. 7. All of the features described with reference to FIGS. 4-7 are applicable to the device 800 and will not be repeated here.

Generally, various example embodiments of the present disclosure may be implemented in hardware, special purpose circuits, software, logic or any combinations thereof. Some aspects may be implemented in hardware while other aspects may be implemented in firmware or software executed by controllers, microprocessors or other computing devices. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

As an example, embodiments of the present disclosure may be described in the context of machine-executable instructions, which is included in program modules executed in devices on a target physical or virtual processor, for example. In general, program modules comprise routines, programs, libraries, objects, classes, components, data structures, and the like, that perform particular tasks or implement particular abstract data structures. The functionality of the program modules may be combined or split between program modules as desired in various embodiments. Machine-executable instructions for program modules may be executed within a local or distributed device. In a distributed device, program modules may be located in both local and remote storage media.

Computer program codes for carrying out methods of the present disclosure may be written in any combination of one or more programming languages. The computer program codes may be provided to a processor of a general-purpose computer, a special purpose computer or other programmable data processing apparatuses, such that the program codes, when executed by the computer or other programmable data processing apparatuses, cause the functions/operations specified in the flowcharts and/or block diagrams to be implemented. The program codes may be executed entirely on a machine, partly on the machine, as a stand-alone software package, partly on the machine and partly on a remote machine or entirely on the remote machine or server.

In the context of the present disclosure, a machine-readable medium may be any tangible medium that contains or stores programs for or related to an instruction executing system, apparatus or device. The machine-readable medium may be a machine-readable signal medium or a machine-readable storage medium and may include but not limited to an electronic, magnetic, optical, electromagnetic, infrared, or semiconductor system, apparatus or device, or any suitable combination thereof. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof.

Furthermore, although operations are depicted in a particular order, it is to be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-21. (canceled)

22. A communication device, comprising:
a controller; and
a memory including instructions, the instructions, when executed by the controller, causing the communication device to perform actions, the actions comprising:
determining whether a time length from a starting time point of the plurality of repetitions to a transmission stopping time point is below a first threshold length;
in response to determining that the time length is below the first threshold length, determining whether the time length exceeds a second threshold length, the second threshold length being less the first threshold length; and
in response to determining that the time length exceeds the second threshold length, partitioning, based on a reference block length, the plurality of repetitions into a block and a truncated block, the block having the reference block length and the truncated block having a truncated block length shorter than the reference block length.

23. The device of claim 22, wherein the actions further comprise:
in response to determining that the time length is below the second threshold length, partitioning the plurality of repetitions into an extended block having an extended block length longer than the reference block length.

24. The device of claim 22, wherein the first threshold length is equal to two times of the reference block length.

25. The device of claim 22, wherein the second threshold length is defined as a function of the reference block length.

26. The device of claim 22, wherein the transmission stopping time point includes at least one of a starting time point of a gap subsequent to the plurality of repetitions or a transmission end.

27. The device of claim 22, wherein the actions further comprise:
in response to determining that the time length exceeds the first threshold length, partitioning a part of the plurality of repetitions into a further block having the reference block length.

28. The device of claim 22, wherein each of the plurality of repetitions includes a demodulation reference signal.

29. A method of block partitioning of a plurality of repetitions, comprising:
determining whether a time length from a starting time point of the plurality of repetitions to a transmission stopping time point is below a first threshold length;
in response to determining that the time length is below the first threshold length, determining whether the time length exceeds a second threshold length, the second threshold length being less the first threshold length; and
in response to determining that the time length exceeds the second threshold length, partitioning, based on a reference block length, the plurality of repetitions into a block and a truncated block, the block having the reference block length and the truncated block having a truncated block length shorter than the reference block length.

30. The method of claim 29, further comprising:
in response to determining that the time length is below the second threshold length, partitioning the plurality of repetitions into an extended block having an extended block length longer than the reference block length.

31. The method of claim 29, wherein the first threshold length is equal to two times of the reference block length.

32. The method of claim 29, wherein the second threshold length is defined as a function of the reference block length.

33. The method of claim 29, wherein the transmission stopping time point includes at least one of a starting time point of a gap subsequent to the plurality of repetitions or a transmission end.

34. The method of claim 29, further comprising:
in response to determining that the time length exceeds the first threshold length, partitioning a part of the plurality of repetitions into a further block having the reference block length.

35. The method of claim 29, wherein each of the plurality of repetitions includes a demodulation reference signal.

36. A computer readable storage medium tangibly storing computer program thereon, the computer program including instructions which, when executed on at least one processor, cause the at least one processor to:
determine whether a time length from a starting time point of the plurality of repetitions to a transmission stopping time point is below a first threshold length;
in response to determining that the time length is below the first threshold length, determine whether the time length exceeds a second threshold length, the second threshold length being less the first threshold length; and
in response to determining that the time length exceeds the second threshold length, partition, based on a reference block length, the plurality of repetitions into a block and a truncated block, the block having the reference block length and the truncated block having a truncated block length shorter than the reference block length.

37. The computer readable storage medium of claim 36, wherein the instructions, when executed on at least one processor, further cause the at least one processor to:
in response to determining that the time length is below the second threshold length, partition the plurality of repetitions into an extended block having an extended block length longer than the reference block length.

38. The computer readable storage medium of claim 36, wherein the first threshold length is equal to two times of the reference block length.

39. The computer readable storage medium of claim 36, wherein the second threshold length is defined as a function of the reference block length.

40. The computer readable storage medium of claim 36, wherein the transmission stopping time point includes at least one of a starting time point of a gap subsequent to the plurality of repetitions or a transmission end.

41. The computer readable storage medium of claim 36, wherein the instructions, when executed on at least one processor, further cause the at least one processor to:
in response to determining that the time length exceeds the first threshold length, partition a part of the plurality of repetitions into a further block having the reference block length.
